(19) United States
(12) Patent Application Publication
(10) Pub. No.: US 2019/0356481 A1
(43) Pub. Date: Nov. 21, 2019

(54) SYSTEM AND METHOD FOR SECURING DIGITAL ASSETS

(71) Applicant: Qredo Ltd., London (GB)

(72) Inventors: Brian Spector, London (GB); Chrstopher Steven Morris, Epping (GB); Howard Kitto, Hampshire (GB); Kealan McCusker, Dublin (IE)

(73) Assignee: Qredo Ltd., London (GB)

(21) Appl. No.: 16/410,656

(22) Filed: May 13, 2019

Related U.S. Application Data
(63) Continuation-in-part of application No. 62/673,706, filed on May 18, 2018.
(60) Provisional application No. 62/834,553, filed on Apr. 16, 2019.
(60) Provisional application No. 62/824,849, filed on Mar. 27, 2019.

(51) Int. Cl. H04L 9/08; H04L 9/32; H04L 29/06; G06Q 20/36; G06Q 20/10; G06Q 20/38

(52) U.S. Cl. CPC H04L 9/0833; H04L 9/3247; H04L 63/045; G06Q 20/3674; H04L 9/0643; G06Q 20/38215; H04L 2209/38; G06Q 2220/00; G06Q 20/10

(57) ABSTRACT

The present invention generally relates to the field of data encryption processes for crypto-currency or other digital asset transactions between a principal and beneficiary utilizing a custodian. Cryptographic protocols protect the asset from the custodian. It can also protect the asset from the principal. It can also protect the asset against the beneficiary until such time as the beneficiary can prove certain logical conditions that give it exclusive control over the digital asset.

### PRIORITY CLAIM

This Utility Patent Application claims priority to U.S. Provisional Patent Application No. 62/824,849 filed on Mar. 27, 2019, and U.S. Provisional Patent Application No. 62/8324553, filed on Apr. 16, 2019 which are all hereby incorporated by reference in their entireties for all they teach.

### FIELD OF INVENTION

The present invention generally relates to the field of securing the transfer of assets represented by digital data items, including crypto-currency or other digital assets.

### BACKGROUND

There is a growing use of data strings, referred to herein as digital assets, that utilize encryption algorithms in order to secure them from theft or tampering. For example, a digital asset can be considered as a means of passing value between parties. Therefore, there are systems that purport to securely store such assets from data loss or from being stolen. Some systems encrypt the digital asset value and associate the encrypted result with a particular customer. Other services operate encryption protocols that data require the owner of the asset to execute a protocol that effectively passes ownership of the asset to the company operating the secure storage service, in return for a contractual promise to deliver the asset back to the owner on demand. Other protocols require that sensitive decryption keys be stored in a repository subject to hacking. These features are troublesome because the service may cease to do business, or be subject to some kind of legal or law enforcement action. Worse, the user is dependent on the internal security protocols of the service, which may be lacking. Therefore, there is a need for an encryption protocol for digital assets that permits the asset to be stored in a distributed ledger with a process for transferring ownership of the digital asset that the owner of the asset can place entirely under the control of the beneficiary of the asset—when the beneficiary can prove it is entitled to ownership, while protecting the asset from the intervening repository operator or other intercepting parties. In this way, the security of the asset is assured: both as a stored data item, due to the public nature of the distributed ledger, and as an encrypted item, in that the value cannot be deduced or transferred without proper execution of the decryption protocol—whether by the principal making a payment transaction through a custody mechanism, or the custody mechanism itself.

### SUMMARY:

One aspect of the invention involves an encryption protocol that when executed only permits parties to a transfer of the digital asset from one party to the other to obtain the digital asset by the recipient satisfying some logical condition that cannot be intercepted by either the service that is executing the transfer or third parties. This is referred to as digital asset custody: the digital asset is only accessible by using a conditional protocol to protect the asset from the custodian and then only make it available to the beneficiary when logical conditions met, but it is still protected from the custodian. In other words, the principal transferring their digital asset selects one more cryptographic conditions that is received by the custodian/server, and the custodian server delivers to the beneficiary a transaction such that the any distributed ledger software client can automatically validate and publish the transaction conveying the asset to the beneficiary when the beneficiary can prove ownership, yet at the same time, the custodian/server does not have access to the asset. In one embodiment, this can be accomplished by the principal, the party making a transfer to the beneficiary, ordering the custodial server to generate a custodial account with a wallet address derived from the inclusion of two logical conditions embodied in a script associated with the transaction: one is a private key proprietary to the beneficiary, the condition being that the corresponding public key (to the private key) included in the script must verify the signature of the corresponding private key held by a beneficiary, and the other is possession of a hashed shared secret key initially generated by the custodian, not the principal, that ultimately gets shared with the beneficiary, by revealing information to the beneficiary which ultimately enables it to securely recreate the shared secret. The principal will have parted ways with the asset upon the custodian furnishing the principal with this wallet address, whereby the principal creates a transaction on the distributed ledger to remit assets or funds to the wallet address. At that point, the network confirms a transaction into the blockchain. The beneficiary's proprietary private key (secret) protects the digital assets from theft by the custodian, as the custodian is not in possession of this secret. The shared secret protocol protects the digital assets from theft by the beneficiary, as the intended beneficiary does not possess this secret until the digital assets have approval to be redeemed out of custody by the beneficiary. The two secrets together protect the digital asset from theft by everyone else. Once a redemption approval has been granted, the custodian creates a transaction on the network for inclusion onto the blockchain, the beneficiary runs the shared secret protocol that derives information from the unrelated transaction which enables the beneficiary to recreate the shared secret using a secure protocol. The invention may be used in conjunction with any cryptocurrency protocol, with any blockchain type data repository or distributed ledger.

In another embodiment, the wallet address generated by the custodian/server is created from a script. In another embodiment, the wallet address generated by the custodian/server is created by using elliptic curve calculation techniques for the addition or combination of two public keys, which are then serially hashed to create the wallet address. In both cases, the invention described herein enables both embodiments.

We first describe the embodiment whereby the wallet address generated by the custodian/server is created from a script. The script itself contains a public key, whose corresponding private key is known only to the beneficiary, and the hash code of a shared secret key generated by the custodian and ultimately available to the beneficiary. Using Bitcoin as a non-limiting example, the ultimate beneficiary must prove to the Bitcoin verifying server the public key in the script corresponds to a private key held by the beneficiary which the verifying server does by checking that a digital signature created by the corresponding private key held by the beneficiary does indeed verify with the public key contained within the script. The shared secret itself is created by the Elliptic Curve Diffie Hellman protocol. The principal receives this wallet address to fund from the custodian and does so by executing a digitally signed transaction, whereby the principal creates this transaction and thereafter the network confirms a transaction into the blockchain. Thereafter, the custodian does not have control over the asset, and any server that can validate the transaction can thereby convey the asset to a destination designated by the beneficiary when the beneficiary can satisfy the logical conditions by running protocols on the two secrets called for within the script; first, using the private key of the corresponding public key contained within the script to create a digital signature so it can be verified by the validating server with the public key contained in the script, and second, by running the shared secret key protocol to generate the shared secret and to hash this so that it equals the value contained within the script. In effect, the beneficiary must prove possession of both secrets in order to obtain the digital asset from the published transaction. A summary of this embodiment is depicted in FIGS. 8 and 9.

Using Bitcoin as an example (although the method will work with any cryptocurrency that supports creating a wallet addresses from scripts), a transaction is created that remits funds to an address derived from the serial hashing of a redeem script (which creates a ‘locking script’) that expresses the logical conditions required to obtain the digital asset. The wallet address is created by Base58Check encoding of the locking script. Going forward, any onward forwarding of Bitcoin received through the transaction has to correctly run a verification protocol against a Bitcoin node which requires a final unlocking script. The unlocking script is simply the data items called upon by the conditions set forth in the redeem script, along with the redeem script itself. The Bitcoin transaction verification protocol validates the data items called for in the redeem script are present in the unlocking script, enabling onward movement of funds by the beneficiary.

In this case, the unlocking script requires possession of the two secret data items described earlier; the beneficiary's private key (to make a digital signature to be verified), and the shared secret key. To be clear, the unlocking script would require a signature made by the intended beneficiary's private key and the shared secret key.

Redemption conditions are cryptographic in nature, but when they are satisfied, result in the generation of the shared secret key by the intended beneficiary that can be used to obtain the digital asset that corresponds to the wallet address located in the transaction record recorded in the Bitcoin blockchain. This happens by means of a further transaction that forwards the digital asset/funds which must be validated by a Bitcoin node running the Bitcoin transaction verification protocol that ultimately transfers the digital asset from the beneficiary's possession to another address designated by the beneficiary. Note that in some cases, the principal and the beneficiary may be the same designated destination, which then establishes the custodial process as a safe repository of the digital asset for the principal that once published, is immutable and can be verified by any Bitcoin server, yet the custodian itself has no control over it. A beneficiary that obtains the shared secret key is now in control of the asset because only the beneficiary can generate a follow-on transaction to move the digital asset to where the beneficiary wants, i.e. they can deposit the asset elsewhere or use it in a transaction as payment. In other words, once the shared secret is obtained by the beneficiary, as a result of the beneficiary secret being used in the transaction, the transfer of the digital asset from principal to beneficiary is complete.

By “prove”, it is meant that a computer program, using the Bitcoin transaction verification protocol, operated by the beneficiary can execute a protocol that demonstrates that the computer contains the data comprising the two secrets. One way that the beneficiary can meet the proof requirement is by means of a secret sharing protocol. In one embodiment, a zero knowledge proof protocol is utilized in order to maintain secrecy of the shared secret against third parties. By zero knowledge proof, it is meant that the beneficiary application can prove to the system that the beneficiary has the shared secret without disclosing the secret. Further, by the principal or beneficiary taking action, it is typically by means of a computer application operating on a device under the control of one or the other, where such program executes the protocol components associated with the principal or beneficiary, respectively.

### DESCRIPTION OF THE FIGURES

The headings provided herein are for convenience only and do not necessarily affect the scope or meaning of the claimed invention. In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 204 is first introduced and discussed with respect to FIG. 2).

FIG. 1. An exemplary architecture of the system

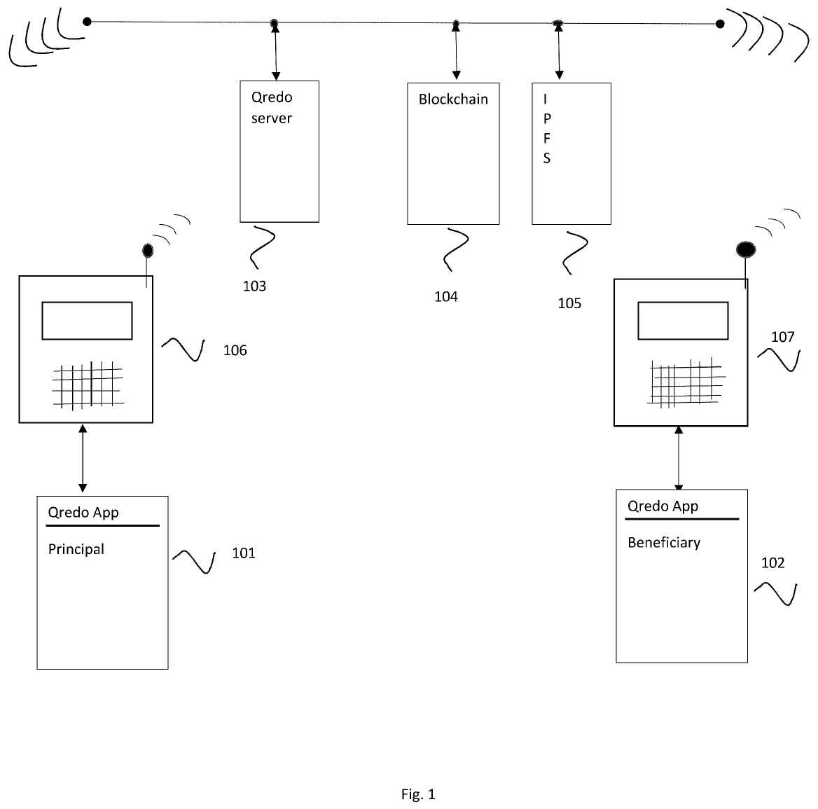

FIG. 2. An example of an initialization/asset deposit process

FIG. 3. An example of a redemption process

FIG. 4. An exemplary flowchart for the custody deposit process

FIG. 5 An exemplary flowchart for the redemption deposit process.

FIG. 6 An example of a locking and unlocking script.

FIG. 7 A diagram depicting the relationship between keys and hashes.

FIG. 8 An alternative embodiment for the deposit process.

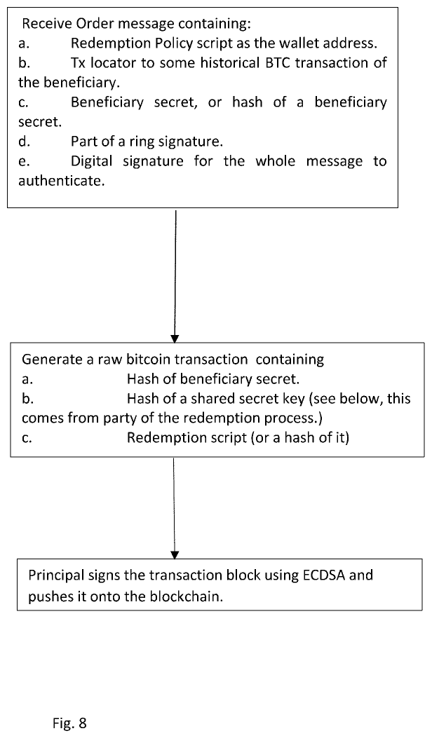

FIG. 9. An alternative embodiment for the redemption process.

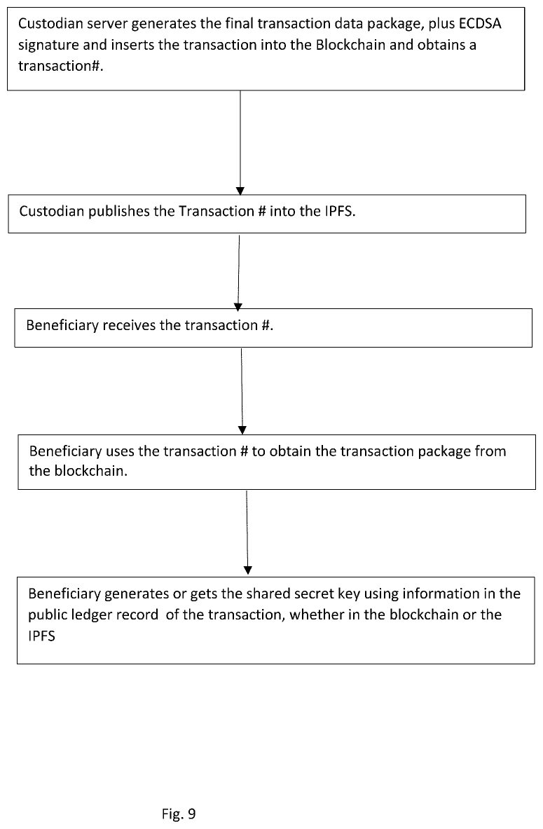

### DETAILED DESCRIPTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other features not described in detail herein. Additionally, some well-known structures or functions may not be shown or described in detail below, so as to avoid unnecessarily obscuring the relevant description. The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section. References to Qredo are the name of a service that has implemented the invention. The Qredo Server executes the server processes in accordance with the invention and the Qredo App can execute either the principal, beneficiary or fiduciary processes.

One embodiment of the invention utilizes the Bitcoin blockchain in combination with a private, immutable, distributed file system as a public repository. The system can operate using mobile devices (106, 107) or equally using any other kind of computing device. The mobile device (106) runs an application operating the fiduciary process (101). The other mobile device (107) operates the beneficiary process (102). The mobile devices communicate with the Internet, which also connects to the Qredo server (103), locations where the blockchain data structure is housed (104) and locations where documents within the private, immutable, distributed file system are stored (105). The Qredo server (103) operates a custody node and contains a private, immutable, distributed file system server node. IPFS, is one such instantiation of a private, immutable, distributed file system (105) with an onboard peer-to-peer data storage architecture that addresses content by the hash of the document, rather than machine location. Further, an example digital asset is a Bitcoin, although the invention can be used by other cryptocurrency processes or other digital asset protocols. The invention may be comprised as a set of one or more computing nodes connected via a data network, for example a set of computer servers connected by a public data network, for example, the Internet. The servers may be adapted to use or interact with the IPFS distributed peer-to-peer content addressable storage system. Each node is referred to as a custody node. In order to store a digital asset using the custody system, a user that owns a digital asset, can store digital assets by being designated as both principal (depositor) and beneficiary of a transfer transaction of the digital asset. Alternatively, the user can use the custody system to convey the digital asset to a recipient, or beneficiary, who is a different person. In this embodiment, the user may launch a program on their compute device, for example, an app on their smartphone. The app creates a digitally signed message that is sent to the custody node requesting that the digital asset be placed into custody for the beneficiary. This step is placing the digital asset into custody.

### 1. Custody Deposit (First of Two Groups of Steps):

We describe the first of two sequential groupings of operational steps to deposit digital assets into custody. In this first half, the custody node generates a digitally signed order document and a digitally signed policy document that outlines the cryptographic redemption conditions required and inserts these documents into IPFS which returns an address location for the documents. The digital signatures on these documents are utilized in the operation.

A required element of the redemption condition as stipulated within the policy document is declaring the identity of the intended beneficiary, in that the identity declaration must include either a) a public key that corresponds to a private key being held by the intended beneficiary or b) a locator to a digitally signed transaction previously created by the beneficiary using the Elliptic Curve Digital Signature Algorithm (ECDSA) with a private key still held by the intended beneficiary. This identity declaration can take the form of a separate identity document within IPFS.

Another required element within the order document is an identity declaration of the principal making the order. This identity declaration can take the form of a separate identity document within IPFS in which an address to this identity document is included within the order document. Central to the identity declaration is the public key of the application operating in the role of the principal, in that this public / private key pair is generated within the application on initial startup and operation, operated by or on behalf of the principal.

The order document is able to be signed with a private key, generated by the principal's Qredo custody node, that can be verified with a public key. Only the Qredo custody node has knowledge of this private key. The signatures created by this key are not deterministic. That is, each time a document is signed the signature is different from the one made previously on exact same document. The public key to verify signatures made by this private key can exist on an identity document within IPFS that declares identity attributes of the custody node. This enables the Qredo server to verify the validity of the digital signature on the order document principal's

Qredo custody node. The order document contains a link to the policy document.

The signature on the policy document is also made by a private key created and only known to the Qredo custody node. This private key's corresponding public key is affixed to the policy document. This private key is used only once, as the signature is deterministic. Signing the policy document again using the same key would produce the same signature. One protocol that may be used for digitally signing policy documents is a threshold ring signature cryptosystem. Threshold ring signatures require t users to cooperate in the signing protocol. Namely, t parties (i₁, i₂, . . . , iₜ) can compute a (t, n)-ring signature, σ, on a message, m, on input (m, Sᵢ₁, Sᵢ₂, . . . , Sᵢₜ, P₁, . . . , Pₙ). However, the parties cooperating in the signing protocol are indistinguishable from other potential signers within the ‘ring’ of potential signers. These possible signers' public keys are affixed to the public key ‘ring’ which is used to verify the completed ring signature. To a party verifying the signature, it is impossible to know which signers, or indeed how many of the potential signers, cooperated to complete the threshold ring signature.

The custody node submits the address of these document locations linked together and contained within an order message which is inserted into and transmitted over the peer to peer network portion of IPFS.

The Qredo Server receives the order message. The Qredo server first validates the digital signatures on the order and policy documents using the public keys referenced previously. Should signatures validate, then the Qredo server generates a new threshold ring signature private key which becomes associated to this specific policy document. The association and the private key is stored within a database within the Qredo server. Depending on the redemption policy dictated by the policy document created by the principal, the Qredo server will undertake a cryptographic process that ultimately decides on how many additional threshold ring signers of the policy document will be required to be in the threshold ring signature. This process enables multiple individuals or processes to be required to approve a redemption, as described later in the application. In the simplest embodiment, there are two signers in the ring. The principal, operating a Qredo node, and the Qredo server. The Qredo server completes the threshold ring signature using the unique threshold ring signature key created specifically to sign this specific policy document from the principal. Once the Qredo server signs the policy document, it runs a signature completion protocol.

Summarizing, the Qredo server computes the completed ring signature, σ, on a message, m, in which the message is the policy document, which has been signed by both the principal, and by the Qredo server. The Qredo server does not publish this signature to external parties. Instead, the Qredo server uses its signature, in conjunction with the principal's signature, to complete the threshold ring signature. This distribution of the cryptographic steps needed to create deposit and redemption orders establishes the cybersecurity benefits of the invention. An attacker looking to compromise the invention has to compromise both the principal's infrastructure and the Qredo server.

Next, the Qredo server uses the completed signature σ as the input into an HMAC protocol. An HMAC is a specific type of cryptographic message authentication code (MAC) involving a cryptographic hash function and a secret cryptographic key (in prior art). The secret cryptographic key is created by the Qredo server using a pseudo random number generator, which is an algorithm that uses mathematical formulas to produce sequences of approximately random numbers. This secret key is then securely stored by the Qredo server and associated to the particular policy document linked to the specific order document created by the principal. The same secret key in the HMAC protocol is used every time the policy document is used as the message to be signed to complete the threshold ring signature arriving at completed signature σ.

The output of the HMAC protocol is deterministic. Meaning, each time the completed threshold ring signature σ is derived from the policy document as the message m to be signed (by the same keys used by the principal and Qredo server previously) and the result is input into the HMAC protocol using the same secret key associated to the policy document, the data returned is always the same. The invention thereby enables the returned deterministic value to be used as a seed to be used in a pseudorandom number generator, as it does not need to be truly random. Because of the nature of pseudo-random number generating algorithms, so long as the original seed is ignored, the rest of the values that the algorithm generates will follow a probability distribution in a pseudorandom manner. A pseudorandom number generator's number sequence is completely determined by the seed: thus, if a pseudorandom number generator is reinitialized with the same seed, it will produce the same sequence of numbers.

This determinism is exploited so that the output from the HMAC protocol is used as a deterministic seed ‘master key’ in creating a hierarchical deterministic cryptocurrency wallet, otherwise known in prior art as an HD Wallet. HD wallets generate a hierarchical tree-like structure of keys which start from the ‘seed master key’. Using Bitcoin as an example, this list of keys are private keys, from which corresponding public keys can be derived, and from these public keys, wallet addresses can also be derived.

Again, using Bitcoin as an example, the Qredo server creates a Bitcoin HD Wallet from the seed master key. The first key in the list is a private key, from which a public key can be derived.

### 2. Custody Deposit (Second of Two Groups of Steps):

The Qredo server now has the ability to create a shared secret key (the “SSK”). In one embodiment, the shared secret key is created using the intended beneficiary's public key and the first private key in the list within the HD Wallet created by the Qredo server. Access to this private key enables a non-authenticated key exchange protocol (using the Elliptic Curve Diffie Hellman or “ECDH” technique) to be run. In the preferred embodiment, using the intended beneficiary's previous Elliptic Curve Digital Signature Algorithm (ECDSA) protocol transaction signature, their public key and the private key from HD Wallet created by and under the control of the Qredo server (201), this enables the Qredo server to complete an authenticated key exchange protocol (using the Elliptic Curve Diffie Hellman ECDH technique). The distinction offers a higher level of trust in how the shared secret key is derived and communicated between the Qredo server and the intended beneficiary.

On the intended beneficiary's side, the process is reversed. In one embodiment, the SSK can be re-created using the Qredo server's public key and the intended beneficiary's private key by way of ECDH. In the preferred embodiment, to achieve authenticated key exchange instead of an unauthenticated key exchange, the SSK is re-created (302) by the intended beneficiary using the 1) Qredo server's public key, 2) a digital signature created by the Qredo server using its corresponding private key, and 3) the private key the intended beneficiary possesses, which corresponds to the public key the Qredo server used in the creation of the SSK in the first place. The Qredo server, using the information in the policy and order documents and the signatures on the policy document, (202) creates the deterministic cryptographic operations to finally generate a private key corresponding to this particular transaction order from the principal, from which it can use as input into an authenticated or non-authenticated Elliptic Curve Diffie Hellman operation via one of the methods above, which finally generates the shared secret key. As a result of the determinism of the operations, this shared secret key can be recreated from deterministic signatures.

The Qredo server next formulates a transaction data package which it also writes into IPFS. The Qredo Server responds with a message, to the principal, that contains a link to the transaction data package over the IPFS network. The transaction data package contains the redeem script that the beneficiary has to satisfy (ultimately with an unlocking script, which is not contained in the transaction data package) in order to be able to access the digital asset, along with the wallet address ultimately derived from the redeem script. The address of this transaction package within IPFS is sent back to the principal in another message, whereby the principal creates a transaction on the distributed ledger to remit assets or funds to the wallet address, thereafter the network confirms this transaction into the blockchain.

To begin the redemption process, the principal obtains an index or transaction number that refers to the transaction that placed the digital asset into custody. The principal can then commence a redemption process that is ultimately validated by a Bitcoin node running the Bitcoin transaction verification protocol by means of the redeem script and unlocking script which proves that the beneficiary is entitled to ownership.

However, in the preferred embodiment, the principal's redemption process would not use a redeem script with unlocking script containing the signature made by the intended beneficiary's private key and the re-created shared secret key. Redeem scripts were created by cryptocurrency developers to accommodate more sophisticated redemption scenarios. However, redeem scripts become part of the blockchain, so the data items like the hash of the shared secret key within the script become part of the blockchain's permanent record. This can create potential privacy and security risks as the presence of data items like the hash of the shared secret key give could give away the fact that the transaction was a custodial arrangement.

In the preferred embodiment, the most basic transaction type would be used which would not leak of information that may be used to confirm a more sophisticated custodial relationship was in effect over the digital asset.

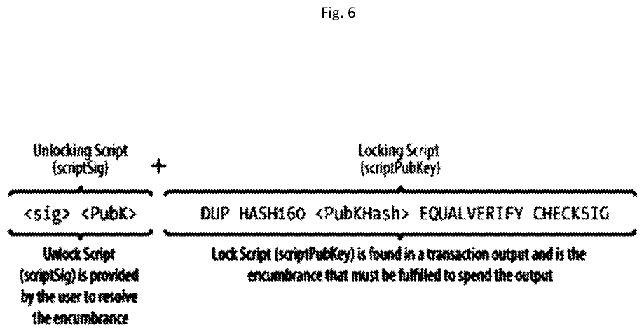

Using Bitcoin as an example, the redeem script would not exist, as the transaction type would be a simple “Pay to Public Key Hash” transaction. In this example, the locking script contains just one reference to the intended beneficiary's public key which would hash to the wallet address of the custodial account. The unlocking script created by the intended beneficiary would contain a signature created with the corresponding private key to the public key within the locking script, along with the public key. The Bitcoin transaction verification protocol would verify the public/private key pair held by the intended beneficiary matches the public key embedded within the locking script. This transaction type is the preferred embodiment as it leaks no information that could be used to construe the transaction was any type but a run of the mill, non-descript cryptocurrency transaction. Example unlocking and locking scripts for this embodiment are presented in FIG. 6.

The preferred embodiment is created by adding a few more additional steps to the Qredo server process so the Qredo server ends up creating two HD Wallets in succession, not just one. The second HD wallet is shared between the Qredo server and the intended beneficiary, becoming the ‘Shared HD Wallet’. (203).

The first additional step the Qredo server takes is to use the created shared secret key not as an input into creating a redeem script, but as the ‘seed master key’ (204) to create this second ‘Shared HD Wallet’. From the Shared HD Wallet, the Qredo server selects the first key in the hierarchical list and from this ECDSA private key creates an ECDSA public key. This public key is then added to the public key listed in the identity declaration (or ID Document within IPFS) of the intended recipient using Elliptic Curve addition. This new public key is then serially hashed to create the cryptocurrency wallet address which is returned to the principal to fund. (205).

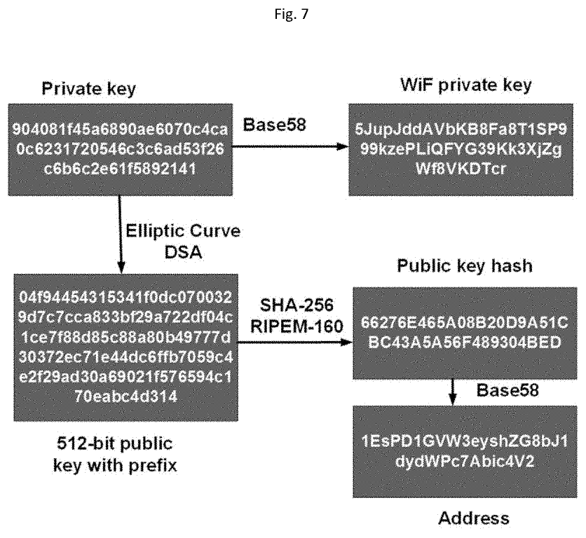

Observe that the common method of generating addresses on an ECDSA cryptocurrency network is to generate a 256-bit ECDSA private key (n) and use a point on the elliptic curve (G). The public key P is then n×G, and a serial hashing method is used to generate a wallet address. The relationships between the keys and hashes in this embodiment is depicted in FIG. 7.

A feature of this type of Elliptic Curve Cryptography used in cryptocurrencies is the fact it is infeasible to obtain the private key from the public key. Further, since the wallet address is derived from the hashing (which is a one-way function) of the public key, it is equally infeasible to obtain the public key from the wallet address.

Recall that the Qredo server creates the second HD Wallet and adds (using the Elliptic Curve technique) the first public key in the HD Wallet to the Beneficiary's public key listed in their ID Document. From here it hashes the combined public key to generate the custodial wallet addresses.

As an example, the ECDSA private key from the second HD Wallet is:
18E14A7B6A307F426A94F8114701E7C8E774E7F9A47E2C2035DB29A206321725
   Which maps to the public key:
0450863AD64A87AE8A2FE83C1AF1A8403CB53F53E486D8511DAD8A04887E5B23522CD 470243453A 299FA9E77237716103ABC11A1DF38855ED6F2EE187E9C582BA6
The intended Beneficiary's ECDSA private key is:
B18427B169E86DE681A1 A62588E1D02AE4A7E83C1B413849989A76282A7B562F
   Which maps to their public key which is available in their ID Document:
049C95E0949E397FACCECF0FE8EAD247E6FD082717E4A4A876049FB34A9ADED110DF EA2EF691CC4 A1410498F4C312F3A94318CD5B6F0E8E92051064876751C8404
By adding the two public keys together, the Qredo server obtains a public key:
0436970CE32E14DC06AC50217CDCF53E628B32810707080D6848D9C8D4BE9FE461E100 E705CCA98 54436A1283210CCEFBB6B16CB9A86B009488922A8F302A27487
   which generates the custodial account wallet address of:
166ev9JXn2rFqiP SQAwM7qJYpNL1JrNf3h
When the intended beneficiary receives from the Qredo server the shared secret key, it uses the shared secret key as the ‘master seed key’ to rebuild the second ‘Shared HD Wallet’.
The intended beneficiary is in possession of both its private key and the private key from the Shared HD Wallet.
By adding the two private keys together, the intended beneficiary generates the private key of:
CA65722CD418ED28EC369E36CFE3B7F3CC1CD035BFBF6469CE759FCA30AD6D54
   which maps to the same public key created previously by the Qredo agent service:
0436970CE32E14DC06AC50217CDCF53E628B32810707080D6848D9C8D4BE9FE461E100
E705CCA98 54436A1283210CCEFBB6B16CB9A86B009488922A8F302A27487
Which was used to generate the custodial account wallet address of:
166ev9JXn2rFqiP SQAwM7qJYpNL1JrNf3h
In this preferred embodiment, the Qredo server presents back to the principal the custodial wallet address written above. It is not necessary for the Qredo server to create a transaction data package which contains the redeem script that the beneficiary has to satisfy (ultimately with an unlocking script, which not contained in the transaction data package) in order to be able to access the digital asset, along with the wallet address ultimately derived from the redeem script.

In this preferred embodiment, when the principal initiates a redemption process that is ultimately validated by a Bitcoin node running the Bitcoin transaction verification protocol, the beneficiary can prove they are entitled to ownership (or create a transaction) simply by having possession of this new private key obtained by way of Elliptic Curve addition as demonstrated above. The Bitcoin transaction verification protocol would verify the public/private key pair held by the intended beneficiary matches the public key embedded within the locking script and can generate the required digital signature.

The Qredo server's ability to transfer information using this shared secret key is not restricted to utilizing it as the seed master key to create HD Wallets. The shared secret key may be used by an intended beneficiary as the seed parameter to generate an encryption key, whereby the intended beneficiary may use the key to encrypt or decrypt information between it and the Qredo server or another party in contact with the Qredo server. Any cryptographic process utilizing the shared secret key that ultimately enables the intended beneficiary to obtain the correct private key that enables control over the funds in a custodial wallet may be utilized as long as the main tenet of the invention is adhered to: that the Qredo server never has any way of computing the private key to control a wallet/custodial account. The intended beneficiary has no way of computing the private key to control the wallet/custodial account until the Qredo server communicates the shared secret key to the intended beneficiary.

Describing another embodiment, the Qredo server processes order:

After the deterministic cryptographic steps described earlier in the first two groupings of sequential steps are completed, the first step in the second series of steps is the Qredo server creates a transaction data package containing or referring to the redeem script which reflects the redemption policy encoded in the principal's order message (containing addresses of order document and policy document). A hash of the redeem script can be hashed again to create a wallet address that is the address of the script. The script contains a hash of a shared secret key and the public key corresponding to the private key the intended beneficiary possesses. The shared secret key is to be shared between the Qredo server and the beneficiary process, as further describe below. Note that the hash functions have to be predetermined ahead of time in order that comparison of hash output be utilized as a way to prove possession of a secret.

Second, the transaction order is acknowledged to the principal process.

Third, the transaction package is encoded and published into a distributed file system at a storage location, by the Qredo server. In one embodiment, the IPFS system may be used as the storage.

Fourth, the Qredo server then sends the generated wallet address and the storage location of the transaction package in the shared file system.

Fifth, the Principal creates a transaction to that wallet address. In one embodiment using Bitcoin as an example, a Bitcoin server can validate this transaction, and have it inserted into the blockchain. At this point the digital asset is now in custody, but the custodian cannot access it. In a sense, the redeem script in the transaction package controls the asset.

In a preferred embodiment, the Qredo server simply sends the generated wallet address to the principal and the principal creates a transaction to that wallet address. There is no transaction package to be created.

Returning in more detail to this embodiment, when the Qredo custody server processes the order, it includes a step to create the redeem script that ultimately appears in the transaction data block once the beneficiary creates a transaction spending onward the Bitcoin to another address. The redeem script itself is based upon the redemption policy given by principal in the policy document. It is a means of proving ownership of the beneficiary private key and the shared secret key. However, additional conditions could be included. The Qredo server has to create the hash of the shared secret key and has to somehow convey the shared secret key to the beneficiary when the beneficiary is authorized to obtain the asset.

Returning in more detail, once the transaction package is digitally signed by the Qredo server, it is inserted into IPFS in order to create an immutable record. Once the principal remits Bitcoin to the wallet address over the distributed ledger and the transaction confirmed into the blockchain, the blockchain establishes the current owner of the asset as the entity that can produce the redeem script (concatenated with the corresponding unlocking script) that is referred to by the transaction package when the owner attempts to create another transaction with funds in the wallet. Control of the asset has thereby passed from the principal to the blockchain: neither Qredo nor the intended beneficiary can access the digital asset. That is because two things are needed for someone, that is, the intended beneficiary, to get access to the digital asset:

The intended beneficiary's private key (which corresponds to the public key used in the protocol to create the shared secret key), and;

The hash of shared secret key.

The beneficiary cannot access the asset unless their computer executing a redemption protocol, proves that it possesses both their private key and the shared secret key, as further described below. The Qredo custody server (or any other server) doesn't know the beneficiary's private key. At this point, the asset is in custody, but it is safe from the custodian and the beneficiary.

In a preferred embodiment, once the principal remits Bitcoin to the wallet address over the distributed ledger and the transaction confirmed into the blockchain, the blockchain establishes the current owner of the asset as the entity that can produce the private key which corresponds to the public key used to create the wallet address. In short, in the preferred embodiment, the Qredo server knows the public key to create the wallet address, but it does not know the private key to create the public key. Only the intended beneficiary can compute the required private key as described above. The Qredo custody server (or any other server) doesn't know the intended beneficiary's private key. The preferred embodiment does not leak any information (because there is no redeem script), yet it still utilizes the shared secret key, but it is safe from the custodian and the beneficiary until the redemption process is approved and the cryptographic workflows complete.

### 3. Summary of Custody Deposit Steps:

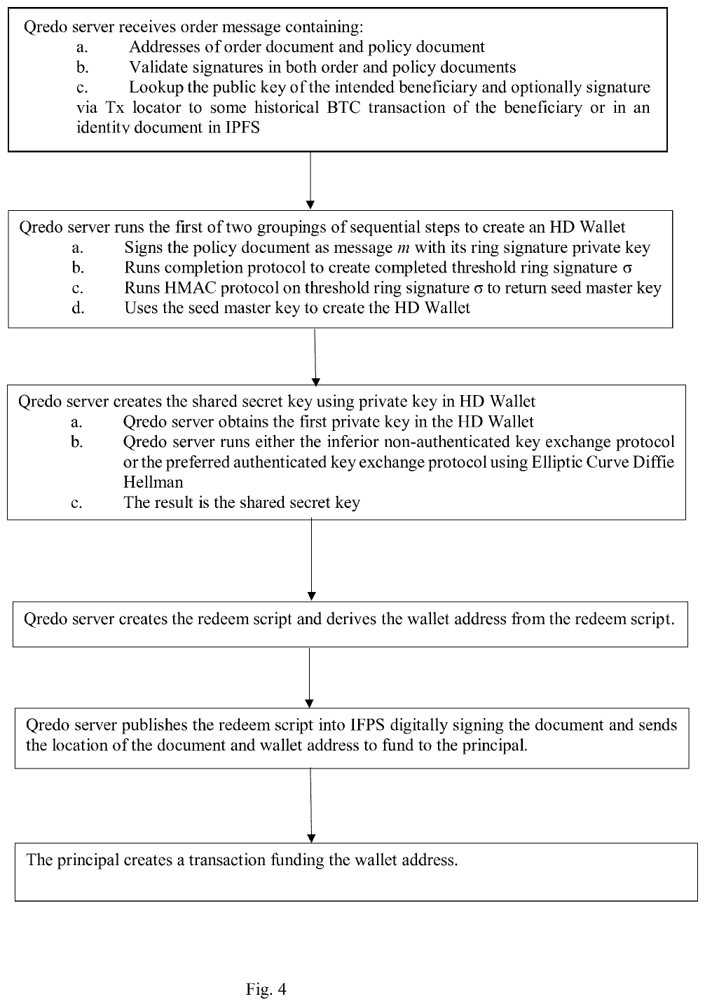

Summarizing the deposit process in sequential steps (FIG. 4):

An embodiment of the invention will execute the following steps:
1. Qredo server receives order message containing:
   a. Addresses of order document and policy document
   b. Validate signatures in both order and policy documents
   c. Lookup the public key of the intended beneficiary and optionally signature via Tx locator to some historical BTC transaction of the beneficiary or in an identity document in IPFS
2. Qredo server runs the first of two groupings of sequential steps to create an HD Wallet
   a. Signs the policy document as message m with its ring signature private key
   b. Runs completion protocol to create completed threshold ring signature σ
   c. Runs HMAC protocol on threshold ring signature σ to return seed master key
   d. Uses the seed master key to create the HD Wallet
3. Qredo server creates the shared secret key using private key in HD Wallet
   a. Qredo server obtains the first private key in the HD Wallet
   b. Qredo server runs either the non-authenticated key exchange protocol or the preferred authenticated key exchange protocol using Elliptic Curve Diffie Hellman
   c. The result is the shared secret key
4. Qredo server creates the redeem script and derives the wallet address from the redeem script.
5. Qredo server publishes the redeem script into IFPS digitally signing the document and sends the location of the document and wallet address to fund to the principal.
6. The principal creates a transaction funding the wallet address.

The preferred embodiment of the invention will execute the following steps:

Steps 1-3c are the same.
4. Qredo server uses the shared secret key as the master seed key to create a second, shared HD Wallet
5. Qredo server obtains the first public key in the HD Wallet and performs Elliptic Curve addition adding the public key in the HD Wallet to the intended beneficiary's public key
6. Qredo server creates the custodial account wallet address from the new public key and sends the wallet address to the principal to fund
7. The principal creates a transaction funding the wallet address

### 4. Redemption Introduction

The redemption process is initiated by the principal in much the same way as the order process was initiated. We describe the first of two sequential groupings of operational steps to redeem digital assets out of custody. In doing so, the invention is unique among digital asset custodians; other digital asset custodians that accept remittance of funds or assets for safekeeping must maintain private keys that control these funds or assets within wallets. These private keys must be safeguarded securely and ultimately used by the custodian to create transactions remitting the funds or assets back to the intended beneficiary over the assets distributed ledger for eventual inclusion into its blockchain or immutable record. The invention described herein operates on a novel principal in that the intended beneficiary can gain control of a custodial account (wallet) that has already been created on the underlying digital asset's distributed ledger and whose blockchain or immutable record already asserts that the corresponding wallet has funds or assets within it.

### 5. Custody Redemption (First of Two Groups of Steps):

In this first half of the grouping of operational steps, the custody node generates a digitally signed transaction order document, this time the order document is a type called a redemption order. The redemption order contains within it the address to the policy document that was also linked to by the original deposit order document.

The redemption order document will be digitally signed by the Qredo node operated by the principal with a private key that the Qredo server can validate with a public key already declared in an identity declaration. The Qredo server validates the digital signatures on the order and policy documents using the public keys referenced previously. If these signatures validate, then the Qredo server obtains from its private database the threshold ring signature private key which was already associated to this specific policy document. It performs this lookup and obtains its threshold ring signature private key to re-generate its part of a threshold ring signature.

The threshold ring signature private keys used to create the individual threshold ring signatures are used only once, because the signatures are deterministic. Signing the same policy document again using the same key would produce the same signature, so the policy document, once signed by the principal, never changes.

The Qredo server uses the private key it has associated to this policy document to create a part threshold ring signature. The Qredo server uses its signature, in conjunction with the principal's signature already contained on the policy document, to complete the threshold ring signature.

Just as in the deposit order steps, the Qredo server uses the completed signature ν as the input into an HMAC protocol. The secret cryptographic key that was stored by the Qredo server and associated to the particular policy document linked to the specific order document created by the principal when the order document was created. The same secret key in the HMAC protocol is used every time the policy document is used as the message to be signed to complete the threshold ring signature arriving at completed signature σ.

The result is input into the HMAC protocol using the same secret key associated to the policy document, so the data returned is always the same. As described previously, computational determinism is exploited so that the output from the HMAC protocol is used as a deterministic seed ‘master key’ in creating a hierarchical deterministic cryptocurrency wallet, otherwise known in prior art as an HD Wallet. HD wallets generate a hierarchical tree-like structure of keys which start from the ‘seed master key’. Using Bitcoin as an example, this list of keys are private keys, from which corresponding public keys can be derived, and from these public keys, wallet addresses can also be derived.

Again, using Bitcoin as an example, the Qredo server creates a Bitcoin HD Wallet from the seed master key. (301).

### 6. Custody Redemption (Second of Two Groups of Steps):

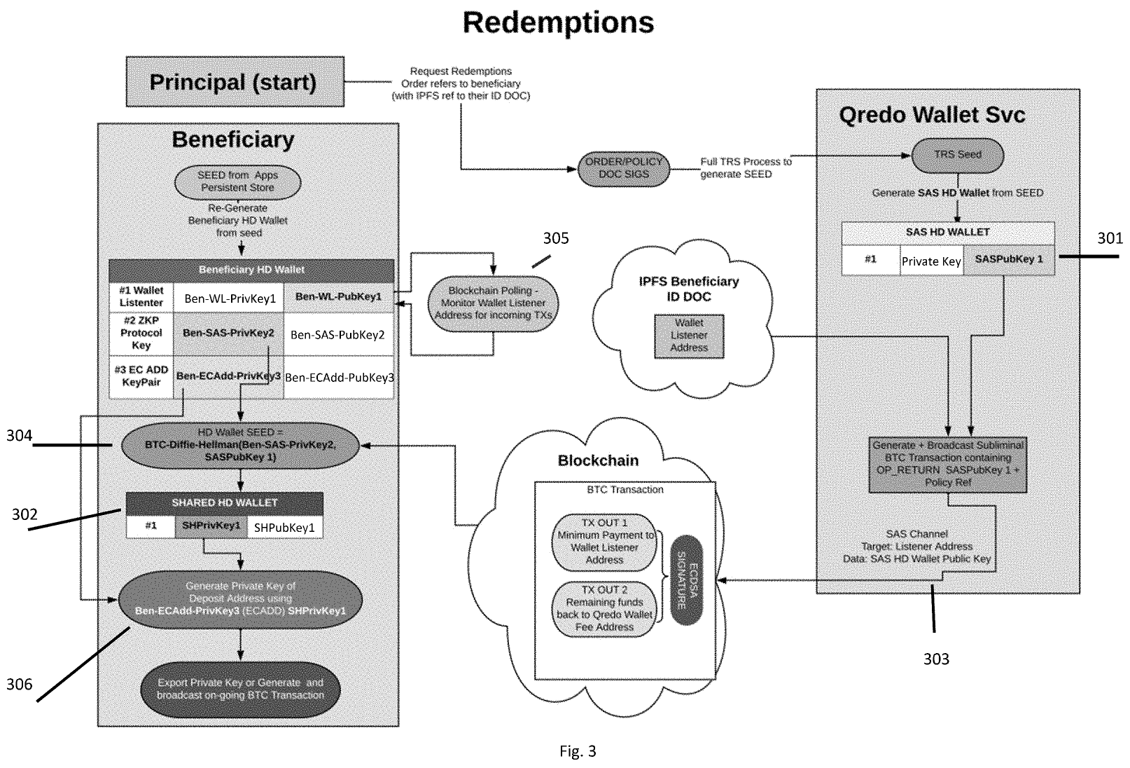

The redemption process relies upon the beneficiary's secure creation of the shared secret key. To enable the intended beneficiary to generate the shared secret key, information must be conveyed to the intended beneficiary. At a minimum, it would be a public key to complete the Elliptic Curve Diffie Hellman (ECDH) protocol. (303). The public key would be from the first HD Wallet generated by the Qredo server (301). This is transmitted through a non-descript transaction sent into the network, confirmed by the network servers and included on the blockchain. (303). (FIG. 3) As described previously, the shared secret key can be re-created on the intended beneficiary's side by using the Qredo server's public key from this first HD Wallet and the intended beneficiary's private key by way of ECDH. (302). In the preferred embodiment, to achieve authenticated key exchange vs unauthenticated key exchange, the shared secret key is re-created by the intended beneficiary using the 1) Qredo server's public key, 2) a digital signature created by the Qredo server using its corresponding private key, and 3) the private key the intended beneficiary possesses, which corresponds to the public key the Qredo server used in the creation of the shared secret key as described previously (302) (FIG. 3).

In another embodiment, the Qredo server would send a direct message to the intended beneficiary that contains the public key that corresponds to the private key used to generate the shared secret key in the deposit order sequence. For one embodiment of the invention, the Qredo server would have to inform the intended beneficiary of the location of the transaction package recorded within IPFS so that it would be able to present the redeem script created by the Qredo server to prove ownership of the assets/funds within the wallet when creating a new transaction spending funds from the wallet. Using Bitcoin as an example, the unlocking script, which would contain a signature from the intended beneficiary's private key along with the shared secret key, must be presented along with the redeem script to a Bitcoin verification server to create a new transaction spending funds from the wallet.

In a preferred embodiment of the invention, communication that ultimately conveyed the location of the redeem script would not be necessary. The shared secret key, once re-created by the intended beneficiary, would be used by the intended beneficiary as the master seed key to create the Shared HD Wallet. (304). By communicating only the public key (for non-authenticated key exchange) or the public key and signature made by corresponding private key (for authenticated key exchange) the intended beneficiary can re-create the Shared HD Wallet.

A simpler embodiment of the invention can be architected in a variety of different methods to accomplish the invention, going forward, we focus on the preferred, embodiment. In the preferred, embodiment, using Bitcoin as an example, we document an embodiment of the invention which requires the intended beneficiary to only possess the private key which can create the wallet address . This avoids the security risk of having additional items such as a shared secret key present in a locking script or stored at rest. The same embodiment can leverage elliptic curve addition more than once to provide a higher degree of cryptographic security and assurance using the authenticated key exchange method as compared to an unauthenticated method. This embodiment of the invention uses a novel approach to transmit the information required by the intended beneficiary to re-create the shared secret key so it may re-create the Shared HD Wallet.

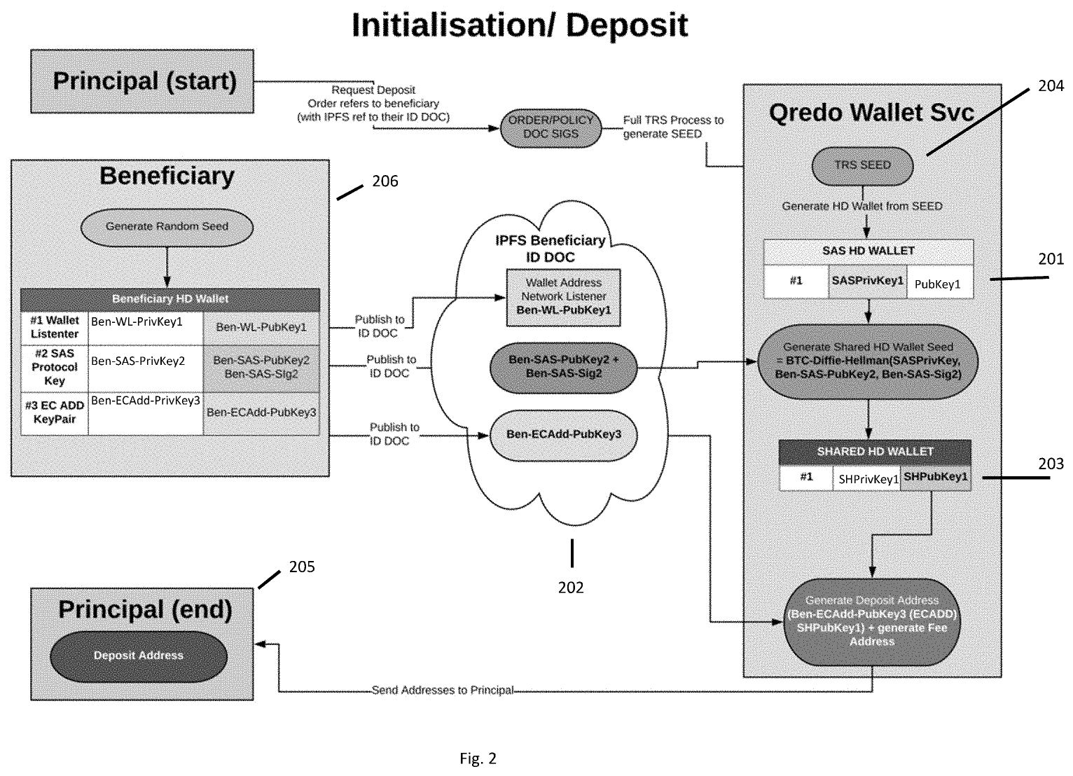

It does this by way of utilizing a larger ring of participant signatures within the threshold ring signature to provide additional security. In the preferred embodiment, during initialization of the intended beneficiary's software application, the software application would have created its own HD wallet from a deterministic master seed key only it possesses (206). (FIG. 2). This process, benefits and rational will be covered in detail in the following paragraphs. The consequence of the intended beneficiary's software application creating its own HD wallet is portability, as HD Wallets can be backed up and re-created using only the deterministic master seed key.

Using the techniques in Bitcoin cryptocurrency as an example, the first key in this HD Wallet is an ECDSA private key, subsequently serially hashed to produce a corresponding public key and then a wallet address from that public key. This wallet address would be declared in an identity declaration to the Qredo server, such as the Identity Document for this particular beneficiary that is stored within IPFS that is made available to the Qredo server. (202).

The second ECDSA key in the HD Wallet is used as the private key and will create the public/private key pair from which the Qredo server will use to create the shared secret key, by taking this second ECDSA public key and an ECDSA signature as input into the shared secret key creation protocol for the authenticated key exchange. The ECDSA public key will be and ECDSA signature would be declared in an identity declaration to the Qredo server, such as the Identity Document for this particular beneficiary that is stored within IPFS that is made available to the Qredo server. (202). (see FIG. 2).

The third ECDSA key in the HD Wallet is used as the private key and will create the public/private key pair from which the Qredo server will use this third ECDSA public key as input into protocol utilizing Elliptic Curve addition to create the wallet address that that is presented to the principal to fund, as described in the previous sections. This third ECDSA public key is also declared an identity declaration to the Qredo server, such as the Identity Document for this particular beneficiary that is stored within IPFS that is made available to the Qredo server. (202).

Continuing with more detail on the preferred embodiment, the Qredo server, will have arrived at the completed threshold ring signature on the basis that the principal will have been validated as the entity that initiated the redemption process by verifying its signature on the redemption order document. The threshold ring signature is run through an HMAC protocol with secret key to generate the first HD Wallet's master seed key. (204).

The next sequence of steps outlines the implementation of both the un-authenticated key exchange and authenticated key exchange for the preferred embodiments of the invention. For this specific instantiation of the protocol, an authenticated key exchange protocol based upon the work of McCorry et al. is utilized. P. McCorry, S. F. Shahandashti, D. Clarke and H. Feng, “Authenticated Key Exchange over Bitcoin,” International Association for Cryptologic Research, no. 308, 2015., is incorporated by reference for all that it teaches.

Using Bitcoin as an example, the Qredo server creates a Bitcoin transaction that is addressed to the wallet address designated in the intended beneficiary's identity declaration, again which could be an Identity Document within IPFS. As will be evident by the description below, the transaction that is addressed to this specific wallet address is unrelated to the custodial account wallet address. The benefit of this action is to preserve the privacy of the intended beneficiary receiving control over the custodial account's wallet. This happens because the transaction to that wallet address conveys information, which is imperceptible to any external viewer, that enables the intended beneficiary to create the master seed key to the Shared HD Wallet, whereupon the intended beneficiary obtains the private key from the Shared HD Wallet, adds it to their existing private key and create the custodial account's wallet private key.

A simpler embodiment of the invention would place an ECDSA public key that enables the intended beneficiary to create a non-authenticated key exchange with the Qredo server within an OP_RETURN transaction. This may introduce privacy and security risks (FIG. 3). The preferred embodiment would place a signature over the transaction that enables the intended beneficiary's software or app to verify the signature with a public key, obtain the signature on the transaction message as input along with the public key as input finally with its private key to arrive at the preferred embodiment of the authenticated key exchange protocol to get the shared secret key.

As described shown in FIG. 3, the second output is a transaction to the intended beneficiary's wallet address, which is a real transaction transferring some nominal value, which is signed with the private key that corresponds to the public key contained within the metadata of the first transaction output, as described previously. (205). The third output maybe an optional change address output. The intended beneficiary's app or software package is programmed to listen for transactions to the wallet address it described in the identity declaration. (305). Once a transaction to that address is received, in another embodiment, the intended beneficiary's app or software package obtains the ECDSA public key from the metadata field in the OP_RETURN transaction output. In a preferred embodiment, they may derive the public key from analyzing the signed message and signature over the message. Running the Elliptic Curve Diffie Hellman protocol (ECDH) using the obtained public key and its private key, the intended beneficiary's app or software package is able to re-create the shared secret key. (304).

In the preferred embodiment of the invention, carrying the ECDSA public key in the OP_RETURN transaction would not be necessary. Using a particular type of encoding, a person could recover the public key that corresponds to the private key used to generate the ECDSA signature knowing only the message it has signed and the signature using techniques in the art. See . “How does recovering the public key from an ECDSA signature work?,” available at crypto.stackexchange.com/questions/18105/how-does-recovering-the-public-key-from-an-ecdsa-signature-work, attached hereto as an appendix, which is incorporated by reference for all that it teaches.

In this preferred embodiment, once a transaction to that address is received, the intended beneficiary's app or software package obtains the ECDSA signature (which has signed the transaction) and recovers the public key, and utilizing both signature and public key as input, along with its private key it will output the shared secret key created by the Qredo server during the deposit order process (FIG. 3). The intended beneficiary's app or software package uses the shared secret key to re-create the Shared HD Wallet. (304). Obtaining the first key in the wallet as the private key, it adds this private key to its existing private key using Elliptic Curve addition. The resulting private key (306) is the private key required to onward spend the funds/assets within the custodial account wallet.

### 7. Sharing the Secret

Here, the, preferred embodiment for a protocol for sharing the secret key between the Qredo server and the intended beneficiary's app or software is presented which is based upon the work of P. McCorry, S. F. Shahandashti, D. Clarke and H. Feng, “Authenticated Key Exchange over Bitcoin,” International Association for Cryptologic Research, no. 308, 2015, is incorporated by reference for all that it teaches. In this description, we assume two individuals, Alice and Bob, who want to share a secret. This protocol takes advantage of a random nonce k from an ECDSA signature, which only exists due to the creation of an ECDSA signature made with the private key. The protocol uses k as a transaction-specific private key and Q=kP as a transaction-specific public key where P is the generator for the elliptic curve. Below is an example where Bob is sharing a secret with Alice, a beneficiary in a transaction conducted using the invention:
1. Alice creates an ECDSA public/private key pair. She generates an ECDSA signature over some message using her ECDSA private key and the signature and message is inserted into IPFS which forms part of an identity declaration, or ID Document. This generates an ID Document address.
2. Alice transmits the ID Document address to Bob.
3. Bob also creates an ECDSA public/private key pair. He generates an ECDSA signature over some message using his ECDSA private key and the signature and message is inserted into IPFS which forms part of an identity declaration, or ID Document. This generates an ID Document address.
4. Bob transmits the ID Document address to Alice.
5. Both Alice and Bob, as part of the setup, will need to derive the transaction-specific private key (random nonce) k from their ECDSA signature before taking part in the key exchange protocol. Additionally, both will need to extract their opposite party's signature (r, s) and attempt to derive their opposite party's transaction-specific public key Q=(x,y).
6. Each user will gain an estimation of their opposite party's public key Q before using their own traction-specific private key k to derive the shared secret key (x_{AB}, ±y_{AB}).
7. Regardless of whether [symbol] =±Q_{A}, the x co-ordinate of k_{B} [symbol] will be the same as that of k_{A} [symbol] . Following the ECDH approach described by V. Miller, “Use of Elliptic Curves in Cryptography,” Advances in Cryptology-CRYPTO85 Proceedings, pp. 417-426, 1986. which is incorporated by reference herein for all that it teaches, the x_{AB} co-ordinate will be used to derive the shared secret key KDF(x_{AB})=κ.
   Using this protocol, the same secret is generated by both Alice and Bob without actually transmitting the shared secret between them, that is, without any interactivity.

Returning to the Redemption steps, when the principal initiates a redemption to the beneficiary, who in this example is Alice, the Qredo server will create a transaction submit to the network for inclusion into the blockchain so that the Beneficiary/Alice can recreate the shared secret key and from it create the Shared HD Wallet. Adding her existing private key to the first key in the HD Wallet (also a private key), Beneficiary/Alice can obtain the private key of the custodial wallet. Once verified, she can submit a new transaction order that moves the digital asset to a designated wallet address of her choosing. The security of this approach is that a third party cannot recover the digital asset without the beneficiary secret and the beneficiary's private key.

The preferred embodiment is cryptographically advanced. Nonetheless, if less security can be tolerated in some applications, other ways of sharing the secret key may be used, for example, physical transfer, using texting through cell-phones, other electronic transmissions, or by means of other PKI transfer mechanisms. For example, the Qredo server could create a secret key, and then encrypt it with the beneficiary's public key, and send the result to the beneficiary, who decrypts it with the beneficiary's private key to get the shared secret key. This may be sufficient in some applications where the principal and beneficiary are the same, and the custody mechanism is to securely store the digital asset.

### 8. Exploiting Threshold Ring Signature for Fiduciary Operations

In some embodiments, the invention may be used so that a third party, referred to as a fiduciary can verify that the beneficiary may obtain the asset. The following describes how a threshold ring signature (TRS) can be utilized in the preferred embodiment. As described previously, the TRS protocol is utilized in order that the Qredo node and the Qredo server must jointly sign a policy document to complete a threshold ring signature, where the Qredo node and Qredo server are two required signers in the ring. The Qredo node has already placed their signature on the policy document, and the address of the policy document is included in the linked deposit order document. When the Qredo server signs the policy document, the signature is not affixed to the policy document, it is created internally within the Qredo server to complete the threshold ring signature only. Once the Qredo server completes the threshold ring signature, the entire signature is run through an HMAC protocol with a dedicated secret key that is associated to this one custodial account. The result of the HMAC protocol is the master seed key of the first HD Wallet used in the custodial account deposit and redemption operations as described previously. By using TRS to generate the HD Wallet master seed key, that wallet master seed key is not stored and therefore the raw key in the clear does not have to be stored either, greatly improving security. That is because the TRS plus secret key in the HMAC can recreate the HD Wallet master seed key, deterministically.

As previously described, the Qredo node operated by the principal and the Qredo server are the signers within the ring, and the Qredo server maintains its signature in secret and uses both signatures on the policy document to complete the message.

The ring of signers can be extended to include additional roles called Fiduciaries. These may be persons or computer programs with logic that must approve the redemption request. By responding to a message requesting approval, a software program, called the Qredo Fiduciary software, will apply a deterministic threshold ring signature to the policy document in addition to the principal's Qredo node and the Qredo server. This software may be run by the Fiduciary on their server or run on a separate server on their behalf.

The Fiduciaries must be declared in advance by listing the addresses of their ID Documents within IPFS inside of the policy document which is linked to from the order document. The Qredo server, upon receiving the deposit order document with linked policy document and after verifying the signatures, would send a remote procedure instruction or API call to the Fiduciary software. Contained within this communication would be the policy document, with a request that it be signed by the Fiduciary. The Fiduciary software would create a specific threshold ring private key associated to this specific policy document, and create a threshold ring signature, and return the signature to the Qredo server.

This process of obtaining the threshold ring signature from Fiduciaries who have been assigned to a custodial account happens when both the account is created during the deposit order process and when the redemption order process is initiated. In all cases, to complete the TRS, the Fiduciaries, who are separate and distinct from the principal operating the Qredo node and from the Qredo server, must sign the policy document with their threshold ring signature private key. These signatures are collected by the Qredo server to complete the TRS. Like the Qredo server's threshold ring signature on the policy document, these signatures from Fiduciaries that are collected by the Qredo server are not disclosed publicly, they are used as inputs by the Qredo server to in the TRS protocol to generate a completed signature.

### 9. Summary of Custody Redemption Steps:

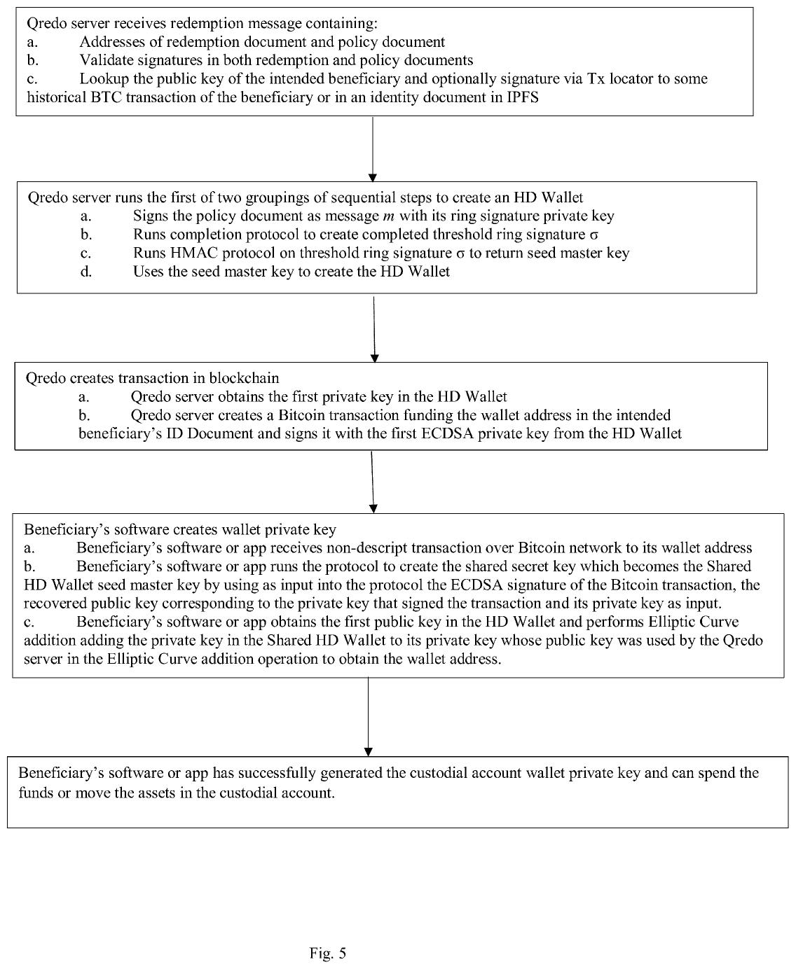

Summarizing the redemption process in sequential steps (FIG. 5):

The preferred, embodiment of the invention will execute the following steps:
1. Qredo server receives redemption message containing:
   a. Addresses of redemption document and policy document
   b. Validate signatures in both redemption and policy documents
   c. Lookup the public key of the intended beneficiary and optionally signature via Tx locator to some historical BTC transaction of the beneficiary or in an identity document in IPFS
2. Qredo server runs the first of two groupings of sequential steps to create an HD Wallet
   a. Signs the policy document as message m with its ring signature private key
   b. Runs completion protocol to create completed threshold ring signature σ
   c. Runs HMAC protocol on threshold ring signature σ to return seed master key
   d. Uses the seed master key to create the HD Wallet
3. Qredo creates transaction in blockchain
   a. Qredo server obtains the first private key in the HD Wallet
   b. Qredo server creates a Bitcoin transaction funding the wallet address in the intended beneficiary's ID Document and signs it with the first ECDSA private key from the HD Wallet
4. Beneficiary's software creates wallet private key
   a. Beneficiary's software or app receives non-descript transaction over Bitcoin network to its wallet address
   b. Beneficiary's software or app runs the protocol to create the shared secret key which becomes the Shared HD Wallet seed master key by using as input into the protocol the ECDSA signature of the Bitcoin transaction, the recovered public key corresponding to the private key that signed the transaction and its private key as input.
   c. Beneficiary's software or app obtains the first private key in the HD Wallet and performs Elliptic Curve addition adding the private key in the Shared HD Wallet to its private key whose public key was used by the Qredo server in the Elliptic Curve addition operation to obtain the wallet address.
5. Beneficiary's software or app has successfully generated the custodial account wallet private key and can spend the funds or move the assets in the custodial account.

In other embodiments, the TRS methodology to generate the shared secret key can be replaced with other protocols. For example:
1. A random number that is hashed, and the random number is the secret.
2. Use of SHA instead of HMAC. (The Secure Hash Algorithms or SHA are a family of The Secure Hash Algorithms are a family of cryptographic hash functions published by the National Institute of Standards and Technology (NIST) as a U.S. Federal Information Processing Standard (FIPS))
3. Use of an approval code that is stored in a database instead of a zero-knowledge proof of the secret.
4. No null transaction to transfer public key data for use with private key data to recreate the secret—just send the shared secret to beneficiary, or just send an approval code or hash of approval code.

### 10. Using the TRS as a Multi-Factor Authentication Protocol

The system uses a computer program operating on the devices under the control of principal, fiduciary and beneficiary. Access to that functionality is preferably secure. This is accomplished by the interaction between the apps and the Qredo servers being further subject to multi-factor authentication. In one embodiment, an operator of the app has to present three identity factors: what you have, what you know, what you are. In one embodiment, the thumbprint: is what you are. An input of a passphrase can demonstrate what you know. An identifier retrieved from the computing device can demonstrate what you have.

Qredo server uses a threshold ring signature algorithm. It uses three different keys out of potential four keys to complete the ring signature. The Qredo server ties the keys to the three identity factors. Each key is unlocked when the correct factor is input. They are
key 1: thumbprint,
key 2, passphrase,
key 3, when you unlock an authenticated/ mac address/stored value. If all three are correct, the ring signature of key1, key2, key3 is complete and may be submitted to the HRM.

Operating Environment: The system is typically comprised of a central server that is connected by a data network to a user's computer. For example, the Qredo custody node may operate on a server or combination of servers. The principal may be an application running on a first person's personal device, and the application's execution operates the processes that conducts the transfer of the digital asset by interacting with the Qredo server. The beneficiary may be an application running on a second person's mobile device that interacts with the Qredo server as well. The IPFS may be a distributed storage system also serviced using servers that may be accessed by either the principal or beneficiary's applications by addressing across the digital network. In addition, in the Bitcoin context, Bitcoin validation servers may also be accessed by the two applications in order to verify the transaction. Further, there may be a set of servers that are connected to the network that act as a distributed ledger, including as an example, the blockchain. The central server may be comprised of one or more computers connected to one or more mass storage devices. The precise architecture of the central server does not limit the claimed invention. In addition, the data network may operate with several levels, such that the user's computer is connected through a fire wall to one server, which routes communications to another server that executes the disclosed methods. The precise details of the data network architecture does not limit the claimed invention. Further, the user's computer platform device may be a laptop or desktop type of personal computer. It can also be a cell phone, smart phone or other handheld device. The precise form factor of the user's computer platform device does not limit the claimed invention. Further, the customer may receive from and transmit data to the central server by means of the Internet, whereby the customer accesses an account using an Internet web-browser and browser displays an interactive web page operatively connected to the central server. The central server transmits and receives data in response to data and commands transmitted from the browser in response to the customer's actuation of the browser user interface. The program can detect the relative location of the cursor when the mouse button is actuated, and interpret a command to be executed based on location on the indicated relative location on the display when the button was pressed. Similarly, the program can detect the location of a touch on the screen. The data file may be an HTML document, the program a web-browser program and the command a hyper-link that causes the browser to request a new HTML document from another remote data network address location. The data file may also contain scripts, which are computer program commands, which are executed by the browser. The data file may also contain references to objects stored either locally or remotely that the browser may then access and display or otherwise render. The browser can thereby fetch additional data that is stored on a remote server accessed using the Internet.

The Internet is a computer network that permits customers operating a personal computer to interact with computer servers located remotely and to view content that is delivered from the servers to the personal computer as data files over the network. In one kind of protocol, the servers present webpages that are rendered on the user's computer platform using a local program known as a browser. The browser receives one or more data files from the server that are displayed on the customer's personal computer screen. The browser seeks those data files from a specific address, which is represented by an alphanumeric string called a Universal Resource Locator (URL). However, the webpage may contain components that are downloaded from a variety of URL's or IP addresses. A website is a collection of related URL's, typically all sharing the same root address or under the control of some entity.

A server may be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Practitioners of ordinary skill will recognize that functions that are accomplished on one server may be partitioned and accomplished on multiple servers that are operatively connected by a computer network by means of appropriate inter process communication. In addition, the access of the website can be by means of an Internet browser accessing a secure or public page or by means of a client program running on a local computer that is connected over a computer network to the server. A data message and data upload or download can be delivered over the Internet using typical protocols, including TCP/IP, HTTP, SMTP, RPC, FTP or other kinds of data communication protocols that permit processes running on two remote computers to exchange information by means of digital network communication. As a result a data message can be a data packet transmitted from or received by a computer containing a destination network address, a destination process or application identifier, and data values that can be parsed at the destination computer located at the destination network address by the destination application in order that the relevant data values are extracted and used by the destination application.

It should be noted that the flow diagrams are used herein to demonstrate various aspects of the invention, and should not be construed to limit the present invention to any particular logic flow or logic implementation except as expressly claimed. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention. The logic described herein may be expressed by computer code that is performed by the computers comprising the system when that code is executed by the computer system. For example, where the disclosure recites a determination or validation whether a condition exists, this may be accomplished by the computer code including a conditional branching statement using a Boolean logical condition, and then that statement resulting in alternative process steps being executed based on the data representation of the condition being determined or validated. In other embodiments, where the disclosure recites a determination, it may be that the computer executes program steps that run a calculation using data representing input state conditions in order to calculate data as a result that represents such a determined result. Similarly, when the invention is described as executing a selection, that may be by the computer system executing code that repeatedly loops on a Boolean logical condition of matching one data value against a set of other data values until a matching data value is found. Some of the logic may be expressed in hardware at a lower level of operation, and that hardware logic utilized by the program logic to provide more complex logical functions. All of these components may be adapted into modules that result in the computer system executing the process that the logic represents.

The method described herein can be executed on a computer system, generally comprised of a central processing unit (CPU) that is operatively connected to a memory device, data input and output circuitry (IO) and computer data network communication circuitry. Computer code executed by the CPU can take data received by the data communication circuitry and store it in the memory device. In addition, the CPU can take data from the I/O circuitry and store it in the memory device. Further, the CPU can take data from a memory device and output it through the IO circuitry or the data communication circuitry. The data stored in memory may be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid state memory. The CPU may perform logic comparisons of one or more of the data items stored in memory or in the cache memory of the CPU, or perform arithmetic operations on the data in order to make selections or determinations using such logical tests or arithmetic operations. The process flow may be altered as a result of such logical tests or arithmetic operations so as to select or determine the next step of a process. The CPU may change an addressing pointer for the next instruction to execute based on the result of such a logical test and thereby perform the change in process flow dependent on the determined logical state.

Examples of well known computing platforms, systems, environments, and/or configurations that may be suitable for use with the invention include, but are not limited to, personal computers, server computers, hand-held, laptop, tablet or mobile computer or communications devices such as cell phones, smart phones and PDA's, multiprocessor systems, microprocessor-based systems, set top boxes, programmable consumer electronics, network PCs, minicomputers, mainframe computers, distributed computing environments that include any of the above systems or devices, and the like. These may operate using as an operating system Windows, iOS, OSX, Android, Linux, Unix, Symbian and Blackberry including the various versions and variants thereof.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., a scripting language, like JAVA, Java Script, an assembly language, or a high-level language such as FORTRAN, C, C++). The source code may be compiled before execution and distributed as object code that is executed on the target computer or compiled as it is executed by the target computer, in each case for use with various operating systems or operating environments. The source code may define and use various data structures and communication messages. The source code may be in a computer executable form (e.g., via an interpreter), or the source code may be converted (e.g., via a translator, assembler, or compiler) into a computer executable form. The steps of

The invention may be described in the general context of computer-executable instructions, such as program modules, being executed by a computer. Generally, program modules include routines, programs, objects, components, data structures, etc., that perform particular tasks or implement particular abstract data types. The computer program and data may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card), or other memory device. The computer program and data may be fixed in any form in a signal that is transmittable to a computer using any of various communication technologies, including, but in no way limited to, analog technologies, digital technologies, optical technologies, wireless technologies, networking technologies, and internetworking technologies. The computer program and data may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

The invention may also be practiced in distributed computing environments where tasks are performed by remote processing devices that are linked through a communications network. In a distributed computing environment, program modules may be located in both local and remote computer storage media including memory storage devices. Practitioners of ordinary skill will recognize that the invention may be executed on one or more computer processors that are linked using a data network, including, for example, the Internet. In another embodiment, different steps of the process can be executed by one or more computers and storage devices geographically separated by connected by a data network in a manner so that they operate together to execute the process steps. In one embodiment, a user's computer can run an application that causes the user's computer to transmit a stream of one or more data packets across a data network to a second computer, referred to here as a server. The server, in turn, may be connected to one or more mass data storage devices where the database is stored. The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer.

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the Appendices is intended only to provide an extremely detailed disclosure of the present invention and is not intended to be limiting. It is appreciated that any of the software components of the present invention may, if desired, be implemented in ROM (read-only memory) form. The software components may, generally, be implemented in hardware, if desired, using conventional techniques.

The foregoing description discloses only exemplary embodiments of the invention.

Modifications of the above disclosed apparatus and methods which fall within the scope of the invention will be readily apparent to those of ordinary skill in the art. Accordingly, while the present invention has been disclosed in connection with exemplary embodiments thereof, it should be understood that other embodiments may fall within the spirit and scope of the invention, as defined by the following claims.

What is claimed:

1. A method executed by a computer system comprised of a first computer, a second computer executing a beneficiary process and at least one server operatively communicating over a data network, for securely transferring a digital asset comprising:
receiving from the first computer a deposit order message comprised of data designating the digital asset,
receiving data corresponding to a beneficiary;
generating using the received beneficiary data a data representing a shared secret;
generating a deposit address using at least part of the shared secret data;
generating a first transaction data package comprised of data that designates the received deposit address as a destination of the transaction; and
receiving by the beneficiary process at least part of the first transaction data package;
obtaining by the beneficiary process at least part of the shared secret data.

2. The method of claim 1 where the step of obtaining is comprised of receiving by the beneficiary process the at least part of the shared secret data.

3. The method of claim 1 where the step of obtaining is comprised of generating by the beneficiary process, the at least part of the shared secret data.

4. The method of claim 1 further comprising:
storing by the system at least part of the first transaction data package in a ledger system.

5. The method of claim 1 further comprising:
generating a redemption script comprised of data representing a first and a second logical tests, the first logical test being proof of possession of the at least part of the shared secret data and the second logical test being proof of possession of a secret data corresponding to the beneficiary process.

6. The method of claim 5 further comprising,
generating the deposit address using the redemption script.

7. The method of claim 1 where the at least part of the shared secret data is a public key of a public key- private key pair.

8. The method of claim 1 where the step of generating by the beneficiary the at least part of the shared secret data is by using an authenticated key exchange protocol.

9. The method of claim 1 further comprising using a cryptographic protocol to validate a logical condition that the beneficiary process is in possession of at least part of the shared secret data.

10. The method of claim 1 where the step of generating using the beneficiary data a data representing a shared secret is comprised of using a completed ring signature as an input.

11. The method of claim 1 where the step of generating using the beneficiary data a data representing a shared secret is comprised of using a deterministic process.

12. A computer system comprised of a first computer executing a principal process, a second computer executing a beneficiary process and at least one server operatively communicating over a data network, for securely transferring control of a digital asset from the principal process to the beneficiary process comprising:
a module adapted by logic to receive a deposit order message comprised of data designating the digital asset and to receive data corresponding to a beneficiary;
a module adapted by logic to use the received beneficiary data to generate a data representing a shared secret and to generate a deposit address data using at least part of the generated shared secret data;
a module adapted by logic to generate a first transaction data package comprised of data that designates the received deposit address as a destination of the transaction;
a module adapted by logic operating as the beneficiary process to receive at least part of the first transaction package and to obtain the at least part of the shared secret data.

13. The system of claim 12 where the module adapted by logic operating as the beneficiary process is further adapted to receive the at least part of the shared secret data.

14. The system of claim 12 where the module adapted by logic operating as the beneficiary process is further adapted to generate the at least part of the shared secret data.

15. The system of claim 12 where the system is further adapted by logic to store at least part the first transaction data package in a ledger system;

16. The system of claim 12 where the system is further adapted by logic to:
generate a redemption script comprised of data representing a first and a second logical test, the first logical test being proof of possession of the at least part of the shared secret data and the second logical test being proof of possession of a secret data corresponding to the beneficiary process.

17. The system of claim 16 where the system is further adapted by logic to generate the deposit address using the redemption script.

18. The system of claim 12 where the beneficiary process is further adapted by logic to generate the data corresponding to the beneficiary process and the at least part of the shared secret data so that they are cryptographically related.

19. The system of claim 12 where the at least part of the shared secret is a public key of a cryptographically related public key and private key pair.

20. The system of claim 15 where the system is further adapted by logic to receive at the beneficiary process the location of the stored transaction data package.

21. The system of claim 12 where the system is further adapted by logic to generate at the server a public-private key pair as the at least part of the shared secret and the beneficiary process is further adapted by logic to generate the private key of the generated public-private key pair.

22. The system of claim 12 where the beneficiary process is further adapted by logic to generate a private key cryptographically related to the deposit address by using the generated private key of the generated public-private key pair.

23. The system of claim 12 where the beneficiary process is further adapted by logic to generate the at least part of the shared secret data using an authenticated key exchange protocol.

24. The system of claim 12 where the beneficiary process is further adapted by logic use a completed ring signature as input to generate the data representing a shared secret.

25. The system of claim 12 where the beneficiary process is further adapted by logic use a deterministic process to generate the data representing a shared secret.

26. A computer system comprised of a first computer executing a principal process, a second computer executing a beneficiary process and at least one server operatively communicating over a data network, adapted by logic to securely transfer control of a digital asset to the beneficiary process comprising:
a module adapted by logic to create a transaction data structure that is comprised of or refers to a redemption script designated by the system as a first payment destination, where the redemption script is comprised of code that expresses a logical test of a first and second logical conditions, the first condition verifying a secret corresponding to the beneficiary process and the second condition verifying possession of a secret shared between the at least one server and the beneficiary process; and
a module adapted by logic to verify that the beneficiary process meets both logical conditions.

27. The system of claim 27 further adapted by logic to transfer the shared secret from at least one server to the beneficiary process.
